(19) United States
(12) Patent Application Publication
(10) Pub. No.: US 2024/0169209 A1
(43) Pub. Date: May 23, 2024

(54) COMPUTER-IMPLEMENTED METHOD FOR PRODUCING A SOFTWARE IMAGE, SUITABLE FOR A NUMERICAL SIMULATION, OF AT LEAST PART OF A REAL CONTROLLER

(71) Applicant: dSPACE GmbH, Paderborn (DE)

(72) Inventors: Markus FRIEDRICH, Paderborn (DE); Tobias GUGGEMOS, Paderborn (DE); Christian NOLDE, Paderborn (DE)

(73) Assignee: dSPACE GmbH, Paderborn (DE)

(21) Appl. No.: 18/427,412

(22) Filed: Jan. 30, 2024

Related U.S. Application Data
(63) Continuation of application No. PCT/EP2022/071305, filed on Jul. 29, 2022.

(30) Foreign Application Priority Data
Jul. 30, 2021 (DE) 10 2021 119 818.6

(51) Int. Cl. G06N 3/09; G06N 3/092

(52) U.S. Cl. CPC G06N 3/09; G06N 3/092

(57) ABSTRACT

A method for creating a software image of at least a part of a control device for a numerical simulation, the control device mapping an input vector of control device input variables to an output vector of control device output variables during operation. The creation of the software image is formed by an artificial neural network or a support vector machine, using an input vector of map input variables having control device input variables of interest, and using an output vector of map output variables having control device output variables of interest. The software image is trained with the aid of supervised learning or with the aid of reinforcement learning, using a plurality of training input vectors of the control device input variables of interest and, in the case of the supervised learning, also using a plurality of corresponding training output vectors of the control device output variables of interest.

This nonprovisional application is a continuation of International Application No. PCT/EP2022/071305, which was filed on Jul. 29, 2022, and which claims priority to German Patent Application No. 10 2021 119 818.6, which was filed in Germany on Jul. 30, 2021, and which are both herein incorporated by reference.

### BACKGROUND OF THE INVENTION

### Field of the Invention

The invention relates to a computer-implemented method for creating a software image of at least one part of a real control device suitable for a numerical simulation, the real control device mapping an input vector of control device input variables to an output vector of control device output variables during operation. The invention further relates to a computer program, including instructions which, when executed with the aid of a computer for training an artificial neural network or a support vector machine, prompt the computer to carry out the specified method.

### Description of the Background Art

Methods of the type described above are used in the area of control device development, more specifically in the area of developing and testing software for control devices. Control devices are microcomputers having an I/O interface, the control device being operatively connected to a technical physical process via this I/O interface, receiving, for example, information from this process in the form of sensor measurement data, and acting upon the process by outputting actuator signals. A signal processing takes place in the control device, the control device input variables are prepared, analyzed, further processed, for example by a regulating algorithm, and corresponding calculated variables are then output via the I/O interface as control device output variables. There are many different fields of application, for example in the automotive sector, in aerospace engineering, and in industrial applications in general, for example in the process industry. The control device input variables and the control device output variables may be present in entirely different forms. They may be analog signals (for example, 4 to 20 mA interface) or digital signals (for example, PWM signals), modulated signals, and even complex signals, for example the messages of a field bus (for example, CAN, FlexRay, etc.) based on a bus protocol. The signals may also be present in different physical forms, for example as electrical signals (current, voltage), as electromagnetic signals in the form of radio waves, or as optical signals, which, however, is less common; However, this is not what matters in the individual case.

The software development for control devices is mapped in the so-called V cycle. In the V cycle, different development stages are passed through, starting with an abstract function test, for example a regulation algorithm, without any reference to the later control device hardware (model in the loop); via the testing of a program code for the series control device to be used later on, the series control device, however, not being present but only mapped in software as a virtual control device (software in the loop, SiL); via the testing of the physically present series control device with the series control device program code, in a fully or partially simulated environment (hardware in the loop, HiL); and finally for the testing of the series control device in the actual physical environment. In the hardware-in-the-loop test (HiL test), the series control device to be tested is connected to an HiL simulator via its I/O interface (or possibly also only a part of its I/O interface), the environment of the control device being (at least partially) simulated on the HiL simulator. For example, if the control device is an engine control device, the simulation takes place on the HiL simulator in keeping with the engine to be driven and possibly also more comprehensive environment components, such as the drive train, vehicle body, all the way to carrying out 3D simulations of road scenes. The environment of the control device to be tested does not have to be completely tested in the HiL simulator, certain components of the environment may also be physically present, for example in the form of other control devices in a control device network.

In the case of the software-in-the-loop test, it is also possible that the virtual control device to be tested interacts with other control devices, so that the functionality of these other peripheral control devices must also be mapped to be able to carry out a useful test of the virtual control device.

### SUMMARY OF THE INVENTION

It is therefore an object of the present invention to provide a method for the illustrated application cases, among other things, with the aid of which it is possible, in the case of an existing real control device, to specify a software image of at least one part of this real control device, it being possible to carry out a numerical simulation of the real control device with the aid of this software image.

The method according to the invention, with the aid of which the object referred to and illustrated above is achieved, is first characterized in that the software image is formed by an artificial neural network or by a support vector machine with the aid of an input vector of map input variables having control device input variables of interest and with the aid of an output vector of map output variables having control device output variables of interest. The software image of the real control device thus does not have to comprise all control device input variables and all control device output variables as map input variables and map output variables, but only those control device input variables and those control output variables are taken into account which are actually of interest.

The software image can be trained with the aid of supervised learning or with the aid of reinforcement learning, using a plurality of training input vectors of the control device input variables of interest and, in the case of the supervised learning, also using a plurality of corresponding training output vectors of the control device output variables of interest. According to the requirements, the functionality of the real control device is to map an input vector of control device input variables to an output vector of control device output variables; the control device output variables thus depend in some way on the control device input variables. This is therefore a typical regression problem.

In the case of reinforcement learning, a training output vector does not necessarily have to be captured and used, although it may also be captured and used. The quality of the output vector output by the software image does not have to take place due to a setpoint/actual comparison of calculated and expected output variables in the case of the reinforcement learning, but instead it may be determined in another way. For this purpose, a training output vector may be used, although it does not have to be used. In the case of supervised learning, the capture and use of the training output vector is mandatory. The discussion below is to be understood on this basis, in which a case distinction is not always made as to whether monitored or reinforcement learning is being used. If reinforcement learning is to be used, a training output vector is not mandatory.

To train the software image, the training input vectors and the corresponding training output vectors are obtained from the operation of the real control device, i.e., from the control device input variables and the control device output variables, The training input vectors and the corresponding training output vectors are “error-free,” since, after all, they come from the operation of the real control device. The pairs of training input vectors and corresponding training output vectors obtained in this way are suitable for training the artificial neural network or the support vector machine as well as for validating the mapping behavior of the software image in the form of the artificial neural network or the support vector machine. The software image of the real control device may thus also be understood as a behavior map.

The supervised learning can include the free parameters of the software image to be set within the scope of the learning process are optimized by maximizing a power function or by minimizing an error function, namely by continuously comparing the output vector of map output variables calculated by the software image with the actual output vector of the control device output variables of interest. In the case of reinforcement learning, a quality of the output vector of map output variables calculated by the software image is continuously determined and optimized, which does not necessarily have to take place using a training output vector.

Due to the proposed method, it is possible to create a software image of a real control device, which may then be used within the scope of other numerical simulations. As a result, it is possible, for example, to map the behavior of the real control device in software in the sector of interest and to use a multiplicity of these software images, for example in parallel HiL simulations or also within the scope of software-in-the-loop simulations, in which participating peripheral control devices may be integrated into the simulation using a software image of this type. This has enormous advantages—purely technical ones as well as with regard to the costs incurred—since the dependence on the existence of a plurality of real control devices is eliminated—only a single one must be present, whose functionality is imitated in the software image.

The software image can be trained with the aid of supervised learning or with the aid of reinforcement learning during the operation of the real control device, using training input vectors obtained during this operation of the real control device and, in the case of supervised learning, also using corresponding training output vectors. This is the “online” case, in which, therefore, the currently present and generated control device input variables and corresponding control device output variables are used as training input vectors and corresponding training output vectors. These may be obtained in the application case of the real control device installed in the real physical process, the operation of the real control device, however, preferably within the scope of a hardware-in-the-loop simulation.

Many real control devices operate as time-deterministic sampling systems, frequently at sampling rates in the millisecond range or in the microsecond range. Even if the control device input variables are not received and processed at a fixed rate, and the control device output variables are not calculated and output at a fixed rate, the control device thus operating, for example, in an event-driven manner, the software image may not be able to be trained with the aid of new training input vectors and corresponding output vectors at the speed at which these training vectors occur. A new pair of input vector of control device input variables and output vector of control device output variables can be used as the training input vector and corresponding training output vector for the training of the software image only if the training of the software image has ended with the last pair of training input vector and corresponding training output vector used for the training. This means that pairs of input vector of control device input variables and output vector of control device output vectors accumulated in the meantime are dropped.

A plurality of pairs of input vector of control device input variables and corresponding output vector of control device output variables are recorded during the operation of the real control device, and the training of the software image takes place independently of the operation of the real control device, using pairs of training input vector and corresponding training output vector, which are obtained from the recorded pairs of input vector of control device input variables and corresponding output vector of control device output variables. This is therefore the “offline” case of the training of the software image.

The use of recorded pairs of input vector of control device input variables and corresponding output vector of control device output variables has a variety of advantages. For example, it is possible to train different software images with the aid of an identical training data set, based on different artificial neural networks or different support vector machines, for example also to train them simultaneously in order to make a selection of the best software image later on. At the same time, the training of the software image is no longer dependent on the generation rate of training input vectors and corresponding training output vectors; the training may take place faster or also slower whenever possible.

In an example of the method, it is provided, regardless of the presence of the “online” case or the “offline” case, that the training of the software image of the real control device takes place using pairs of training input vector and corresponding training output vector, which are obtained from temporally equidistantly consecutive pairs of input vector of control device input variables and corresponding output vector of control device output variables. The training particularly preferably takes place using a series of multiple pairs of training input vector and corresponding training output vector, which are obtained from temporally gaplessly consecutive pairs of input vector of control device input variables and corresponding output vector of control device output variables. In the “online” case, whether this stipulation is able to be met depends on the sampling rate of the real control device and the maximum training speed of the software image.

The training input vectors and the corresponding training output vectors obtained from the operation of the real control device can be accepted or discarded in a selection step, based on a selection criterion for training the software image. The selection criterion could be made up of a predefined value range for at least a portion of the control device input variables of interest and/or a portion of the control device output variables of interest. This makes it possible, for example, to influence whether marginal control device input variables or control device output variables are taken into account in the training.

The operation of the real control device can be carried out to obtain the training input vectors and the corresponding training output vectors in such a way that at least a portion of the control device input variables and at least a portion of the control device output variables take on values which cover at least a predefined interval of the theoretically possible value range. According to this approach, care is taken to ensure that a certain value range is in fact covered by the training input vectors and corresponding training output vectors, so that it may be ensured that training data are actually present in the desired value range.

An interval within the scope of at least 70% of the theoretically possible value range is advantageously covered, an interval within the scope of at least 80% of the theoretically possible value range is preferably covered, and an interval within the scope of at least 90% of the theoretically possible value range is particularly preferably covered.

The artificial neural network can be implemented with the aid of an input layer having at least a number of input neurons corresponding to the number of control device input variables of interest for supplying the control device input variables of interest, with the aid of an output layer having at least a number of output neurons corresponding to the number of control device output variables of interest for outputting the control device output variables of interest, each input neuron being linked to at least one neuron of the intermediate layer via a directed and weighted signal path, and at least one neuron of the intermediate layer being linked to the output neuron of the output layer via a directed and weighted signal path. This is the usual structure of an artificial neural network. The links between the different layers must in any case be so complete that a continuous signal path exists between an input neuron and an output neuron, because the influence of input variables on output variables does not otherwise exist. A completely linked neural network is first preferably trained, in which each input neuron is therefore linked to each neuron of the intermediate layer via directed and weighted signal paths, and each neuron of the intermediate layer being linked to the output neuron of the output layer via a direct and weighted signal path.

As discussed above, the object referred to at the outset is also achieved by a computer program, including instructions which, when executed with the aid of a computer for training an artificial neural network or a support vector machine, prompt the computer to carry out the method described above.

Specifically, a multiplicity of possibilities now exist for embodying and refining the method according to the invention and the computer program according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a computer-implement method according to the invention for creating a software image of a real control device suitable for a numerical simulation;

FIG. 2 shows an example of a computer-implement method according to the invention for creating a software image of a real control device suitable for a numerical simulation; and

FIG. 3 shows an artificial neural network as a software image of a real control device.

### DETAILED DESCRIPTION

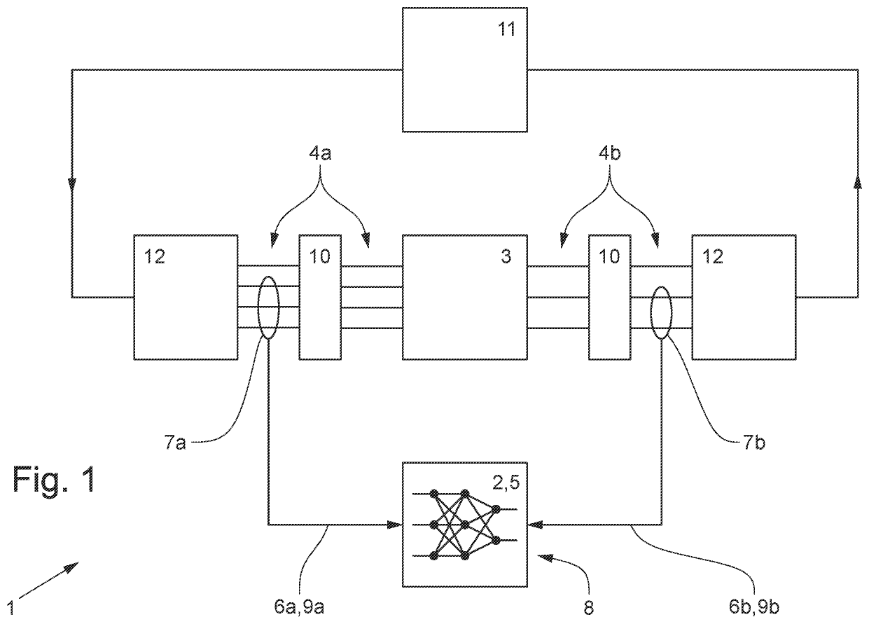

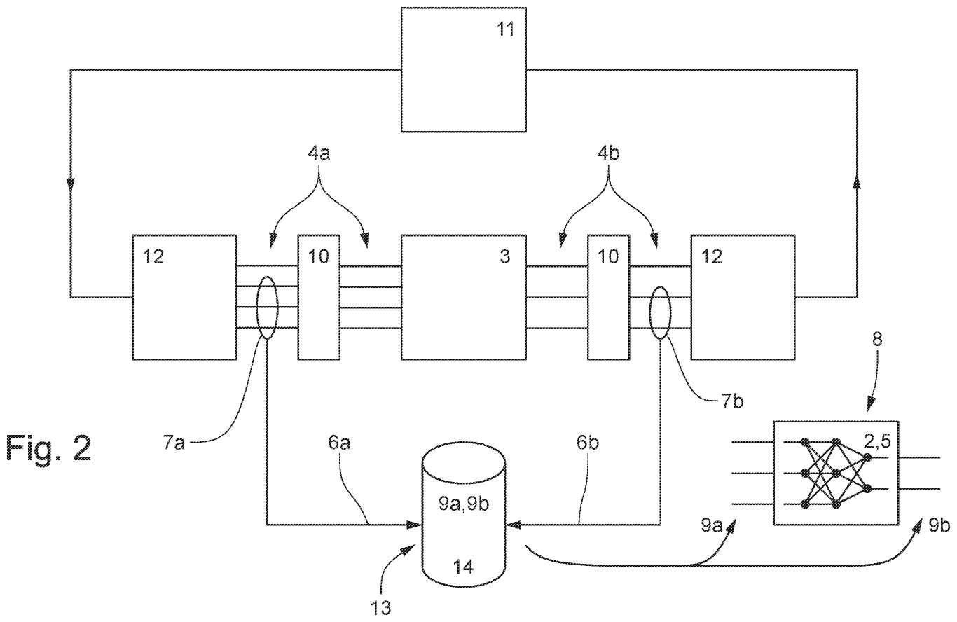

FIGS. 1 and 2 each show a computer-implemented method 1 for creating a software image 2 of at least a part of a real control device 3 suitable for a numeric simulation, real control device 3 mapping an input vector of control device input variables 4a to an output vector of control device output variables 4b during operation. This means that real control device 3 ascertains control device output variables 4b from control device input variables 4a received via its I/O interface, which is not illustrated separately here, using different calculations, and also outputs them via its I/O interface. The mapping of input variables to output variables is to be understood in this sense.

An application case, in which control device 3 is connected to a hardware-in-the-loop simulator, is illustrated in each of the two FIGS. 1 and 2. The hardware-in-the-loop simulator, which is not represented here in detail includes one or multiple computing units and I/O interfaces 10. Environment model 11 is calculated on the computing units in the form of different processor boards, and the physical model variables are then converted 12 into the corresponding physical variables of the sensor signals, or the electrical physical signals are converted 12 into corresponding model signals or environment model 11.

As is apparent from FIGS. 1 and 2, no distinction is made here—nor does a distinction have to be made—as to whether control device input variables 4a and control device output variables 4b are the actual electrical signals at the input pins or the output pins of real control device 3 itself or whether they are the corresponding numerical form of these control device input variables or the numerical form of the corresponding control device output variables. In the examples illustrated in the figures, control device input variables 4a and control device output variables 4b are each understood to be the numerical equivalent of the electrical input and output variables, which is also useful, since software image 2 maps the functionality of real control device 3 within the scope of a numerical simulation, and therefore the corresponding numerical values are used for the electrical input and output variables of real control device 3.

However, what the two illustrated methods 1 share in common is that software image 2 is formed by an artificial neural network 5 having an input vector of map input variables 6a with control device input variable 7a of interest and having an output vector of map output variables 6a with control device output variables 7b of interest. In each case, it is illustrated in the figures that the input vector of control device input variables 4a comprises four signal lines, although only three control device input variables 7a of interest are of interest, which are used as map input variables 6a. This applies similarly to control device output variables 7b of interest, which are used as map output variables 6b.

Software image 2 is trained 8 with the aid of supervised learning, using a plurality of training input vectors 7a of control device input variables 7a of interest and using a plurality of corresponding training output vectors 9b of control device output vectors 7b of interest. The problem which frequently occurs when training software images formed by an artificial neural network or by a support vector machine, in that a sufficient amount of high-quality training data is not available, does not occur in the present case, since, after all, a real control device 3 is present, with the aid of which a completely sufficient and practically inexhaustible number of training vectors 9 may be generated during real operation. In any case, necessary training input vectors 9a and corresponding training output vectors 9b are obtained from the operation of real control device 3, i.e., from control device input variables 4a and control device output variables 4b, Due to training 8 of software image 2, a behavior map of the functionality of interest of real control device 3 is achieved.

The case of training 8 software image 2 with the aid of reinforcement learning, which is not illustrated here, differs from the case of supervised learning in that a training output vector 9b does not necessarily have to be determined and used for training 8 software image 2—although it may be used.

FIG. 1 shows that software image 2 is trained with the aid of supervised learning during the operation of real control device 3, using training input vectors 9a and corresponding training output vectors 9b obtained during this operation of real control device 2, the operation of real control device 3 taking place within the scope of a hardware-in-the-loop simulation. The “online” case of method 1 is thus illustrated in FIG. 1. A new pair of input vector of control device input variables 4a and output vector of control device output variables 4b is used here as training input vector 9a and corresponding training output vector 9b for the training of software image 2 only if training 8 of software image 2 has ended with the last pair of training input vector 9a and corresponding training output vector 9b used for training 8. Pairs of input vector of control device input variables 4a and output vector of control device output vectors 4b accumulated in the meantime are dropped for training 8. Software image 2 is thus supplied with new training data as quickly as possible in this way, but not faster than possible within the scope of the “online” application case.

FIG. 2 shows that method 1 is operated in such a way that a plurality of pairs of input vector of control device input variables 4a and corresponding output vector of control device output variables 4b is recorded 13 during the operation of real control device 3, using a data memory 14 provided for this purpose. Training 8 of software image 2 is carried out independently of the operation of real control device 3, using pairs of training input vector 9a and corresponding training output vector 9b, which are obtained from the recorded pairs of input vector of control device input variables 4a and corresponding output vector of control device output variables 4b. This is the so-called “offline” case, in which there is no need to carry out training 8 of software image 2 at the same time as the operation of real control device 3.

In the examples according to FIGS. 1 and 2, real control device 3 is a deterministic sampling system having equidistant sampling points. Training 8 of software image 2 of real control device 3 takes place in each case using pairs of training input vector 9a and corresponding training output vector 9b, which are obtained from temporally equidistantly consecutive pairs of input vector of control device input variables 4a and corresponding output vector of control device output variables 4b. In the case of FIG. 2, where a training 8 of software image 2 does not have to take place in real time, training 8 particularly preferably takes place using a series of multiple pairs of training input vector 9a and corresponding training output vector 9b, which are obtained from temporally gaplessly consecutive pairs of input vector of control device input variables 4a and corresponding output vector of control device output variables 4b.

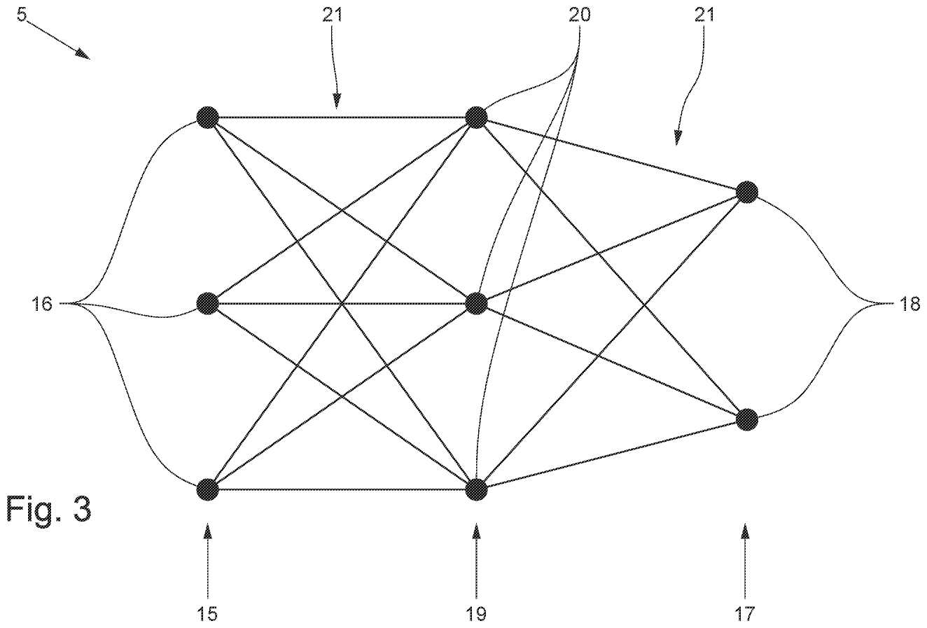

Finally, FIG. 3 shows how artificial neural network 5 is implemented in examples 1 and 2, namely using an input layer 15 having at least a number—three in this case—of input neurons 16 corresponding to the number of control device input variables 7a of interest for the purpose of supplying control device input variables 7a of interest. Artificial neural network 5 further includes an output layer 17 having a number of output neurons 18—two in this case—corresponding to the number of control device output variables 7b of interest for the purpose of outputting control device output variables 7b of interest. An intermediate layer 19 having three neurons 20 is also provided, each input neuron 16 being linked in the present case to each neuron 20 of intermediate layer 19 via directed and weighted signal paths 21, the weighting of the signal paths being implemented by multipliers in the signal path, which are not illustrated in detail. Each neuron 20 of intermediate layer 19 is furthermore linked to the two output neurons 18 of output layer 17 via a directed and weighted signal path 21. Training 8 of artificial neural network 5 includes the adaptation of the multipliers of weighted signal paths 21 between the different layers 15, 17, 19 of artificial neural network 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method to create a software image of at least a part of a real control device adapted for a numeric simulation, the real control device mapping an input vector of control device input variables to an output vector of control device output variables during operation, the method comprising:
forming the software image by an artificial neural network or by a support vector machine having an input vector of map input variables with control device input variables of interest and having an output vector of map output variables with control device output variables of interest;
training the software image with the aid of supervised learning or with the aid of reinforcement learning using a plurality of training input vectors of the control device input variables of interest and, in the case of supervised learning, using a plurality of corresponding training output vectors of the control device output variables of interest; and
obtaining the training input vectors and, in the case of supervised learning, also the corresponding training output vectors from the operation of the real control device.

2. The method according to claim 1, wherein the software image is trained with the aid of supervised learning or with the aid of reinforcement learning during the operation of the real control device, using training input vectors, and, in the case of supervised learning, corresponding training output vectors obtained during this operation of the real control device, the operation of the real control device taking place within the scope of a hardware-in-the-loop simulation.

3. The method according to claim 2, wherein a new pair of input vector of control device input variables and output vector of control device output variables is used as a training input vector and a corresponding training output vector for the training of the software image only if the training of the software image has ended with the last pair of training input vector and corresponding training output vector used for the training or pairs of input vector of control device input variables and output vector of control device output variables accumulated in the meantime are dropped.

4. The method according to claim 1, wherein a plurality of pairs of input vector of control device input variables and corresponding output vector of control device output variables are recorded during the operation of the real control device, and the training of the software image takes place independently of the operation of the real control device, using pairs of training input vector and corresponding training output vector, which are obtained from the recorded pairs of input vector of control device input variables and corresponding output vector of control device output variables.

5. The method according to claim 1, wherein the training of the software image of the real control device takes place using pairs of training input vector and corresponding training output vector, which are obtained from temporally equidistantly consecutive pairs of input vector of control device input variables and corresponding output vector of control device output variables or using a series of multiple pairs of training input vector and corresponding training output vector, which are obtained from temporally gaplessly consecutive pairs of input vector of control device input variables and corresponding output vector of control device output variables.

6. The method according to claim 1, wherein the training input vectors obtained from the operation of the real control device and the corresponding training output vectors are accepted or discarded in a selection step, based on a selection criterion for the training of the software image.

7. The method according to claim 6, wherein the selection criterion is made up of a predefined value range for at least a portion of the control device input variables of interest and/or a portion of the control device output variables of interest.

8. The method according to claim 1, wherein the operation of the real control device is carried out to obtain the training input vectors and the corresponding training output vectors such that at least a portion of the control device input variables and at least a portion of the control device output variables take on values which cover at least a predefined interval of the theoretically possible value range, in particular cover an interval within the scope of at least 70% of the theoretically possible value range, preferably cover an interval within the scope of at least 80% of the theoretically possible value range, and particularly preferably cover an interval within the scope of at least 90% of the theoretically possible value range.

9. The method according to claim 1, wherein the artificial neural network is implemented with the aid of an input layer having at least a number of input neurons corresponding to the number of control device input variables of interest for supplying the control device input variables of interest, with the aid of an output layer having at least a number of output neurons corresponding to the number of control device output variables of interest for outputting the control device output variables of interest, and including at least one intermediate layer having at least two neurons, each input neuron being linked to at least one neuron of the intermediate layer via directed and weighted signal paths, and each neuron of the intermediate layer being linked to at least one output neuron of the output layer via a directed and weighted signal path.

10. A computer program comprising instructions, which, when executed with the aid of a computer for training an artificial neural network or a support vector machine, prompt the computer to carry out the method according to claim 1.

11. The method according to claim 1, wherein the training input vectors and/or the corresponding training output vectors are obtained from the control device input variables and the control device output variables.
